(19) United States
(12) Patent Application Publication
(10) Pub. No.: US 2012/0273073 A1
(43) Pub. Date: Nov. 1, 2012

(54) Duct Plug Inflatable Safety Device

(76) Inventors: Kyle Kutach, Ovilla, TX (US); Robert Hinds, Midlothian, TX (US)

(21) Appl. No.: 13/505,500

(22) PCT Filed: Nov. 3, 2010
(86) PCT No.: PCT/IB2010/002801

§ 371 Date: May 31, 2012

Related U.S. Application Data
(60) Provisional application No. 61/258,025, filed on Nov. 4, 2009.

(51) Int. Cl. F16K 7/10; F16L 55/134

(52) U.S. Cl. 137/596; 138/93; 29/428

(57) ABSTRACT

An inflatable safety device is provided. A method of using an inflatable safety device in an overhead conduit or area of a cement manufacturing plant to keep debris from falling on a worker below the device, is also provided.

This present disclosure relates generally to safety devices and more particularly to an inflatable safety device.

Cement manufacturing plants contain many tubular or generally cylindrical overhead conduits and areas such as smoke stacks, ducts, kilns and the like. See for example, U.S. Pat. No. 7,048,784 entitled “Method and System for Treating Exhaust Gas from Cement Manufacturing Equipment” which issued to Terasaki et al. on May 23, 2006, and U.S. Pat. No. 6,264,738 entitled “Method of Producing Cement Clinker and Associated Device” which issued to Lorke et al. on Jul. 24, 2001. Both of these patents are incorporated by reference herein. When workers need to enter such conduits and areas for maintenance, there is always the risk that debris, such as bricks, refractory materials, ash chunks and other loose items, may fall onto the workers.

It is known to provide rigid temporary cages which are made of metal poles and mesh material (similar to a chain link fence) which must be assembled in place and which force workers to be directly underneath their protective canopy in order to enjoy any protection from falling objects. These conventional devices, however, are complicated, time consuming to erect and cannot be used when erecting scaffolding inside of a duct.

### SUMMARY

In accordance with the present invention, an inflatable safety device according to claims 1 to 14 is provided. In another aspect, an inflatable device is used to temporarily plug a conduit or area of a cement manufacturing plant. According to claims 15 to 20 a method of using an inflatable safety device in an overhead conduit or area of a cement manufacturing plant to keep debris from falling on a worker below the device, is also provided.

In a further aspect, a duct plug inflatable safety device is designed as a readily portable, easily deployable (1 or 2 person) bladder which can be quickly installed in ducts, stacks and other similarly configured areas to protect workers from falling objects or items when they are required to work in such spaces. The device is intended to be deployed in such areas above where workers must be present and then inflated to form an impenetrable barrier against falling brick, refractory, or other material build-up which can dislodge from the interior of conduit surfaces.

The present device is advantageous over conventional systems. In one aspect, the present device is portable and lightweight; it is easy to move from one application area to another with little preparation. In another aspect, the device requires no assembly, only inflation with a pressurized plant air supply (or user-supplied portable compressor). Likewise, once it is no longer needed, it is quick to deflate and remove, allowing rapid return of normal operations in the work area. In another aspect, the device is easy to use, requires little specialized training and no unusual ancillary tooling or equipment. Multiple fill points and dump valves allow for rapid inflation and deflation. In another aspect, the device is resilient since it is made of a heavy vinyl material that is resistant to tearing, abrasion and punctures. Fittings are industrial grade plastics and metal couplings.

In another aspect, the present device is much less expensive than portable cage-type units currently in use to protect workers. In another aspect, the device is versatile since it easily fits a wide range of commonly encountered duct work—from 3 foot diameter all the way to 12+ foot diameter, regardless of shape (rounded, oval or squared ducts or stacks) and regardless of bends or angles in the ducts and conduits. By virtue of its design, the device will conform to virtually any interior surface irrespective of shape or configuration and remain firmly in place without concern regarding the build-up of material on the interior. In another aspect, the device is heat-resistant and can be deployed in areas where residual heat remains such as a smokestack or kiln. In another aspect, the device is non-permanent since it does not require fittings, rigid framework or any other permanent modifications to the stacks or ducts in which it is deployed. It remains deployed and in place by friction and pressure against the interior bearing surfaces. In another aspect, the device does not expose workers who are deploying or removing the device to be exposed to any overhead or falling object hazards. In another aspect, the device is durable since its high strength vinyl material and the natural shock-absorbing abilities of an inflated object allow effective protection against a wide range and weight of falling objects as well as abrasion from coating materials commonly encountered in ducts in cement plants. The present device and method provide a quick and easily deployable, highly adaptable protective barrier against dropped or failing objects or materials commonly present in vertical or high-angle ducts and stacks to protect workers who must work in or underneath such structures.

Further areas of applicability will become apparent from the following description, drawings and appended claims. The description and specific examples in this disclosure are intended for purposes of illustration only and are not intended to limit the scope of the present invention.

### BRIEF DESCRIPTION OF DRAWINGS

FIG. 1 is a cross-sectional view showing an inflatable device installed in a smokestack;

FIG. 2 is a perspective view showing the inflatable device;

FIG. 3 is a bottom elevational view showing the inflatable device; and

FIG. 4 is a top elevational view showing the inflatable device.

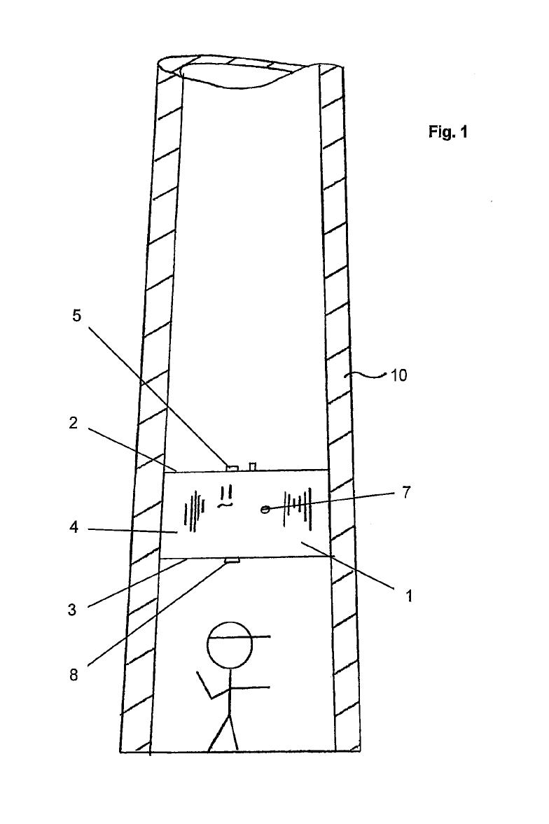

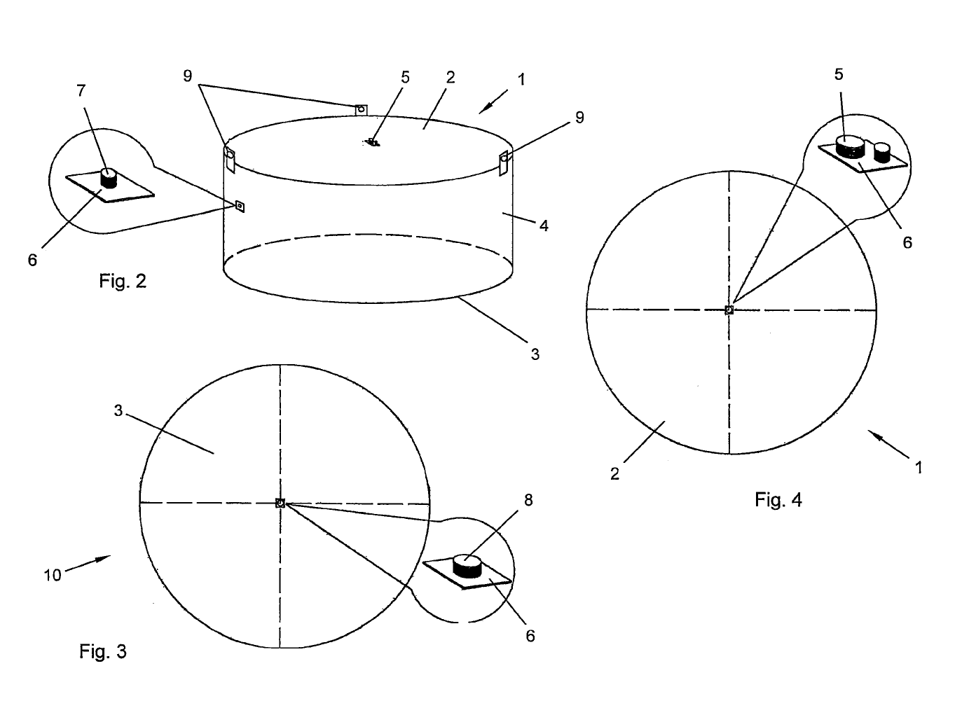

### DETAILED DESCRIPTION

Referring to the Figures, the inflatable duct plug safety device 1 consists of an inflatable vinyl bladder, roughly twelve feet in diameter and five feet in height, which is generally cylindrical in shape when fully inflated. When inflated, the top 2 of the bladder 1 bows upward slightly, presenting a somewhat convex surface which assists in diverting and absorbing the energy of falling objects. The material of construction is a heavyweight (18 ounce/yd²) reinforced vinyl, which includes three pieces: one each for the top 2 and bottom 3 of the cylinder 1 and the third, a continuous sheet of the same material which is stitched into a cylindrical tube to form the walls 4 of the cylinder 1 and which is then stitched to the top 2 and bottom 3. All stitched seams are sealed with an adhesive material to provide air tightness.

Mounted at the mid-point of the top 2 of the cylinder 1 is a fill and dump valve assembly 5, which has a threaded 1.5 inch×¾ inch NPT nipple, allowing attachment of a number of standard air fittings (used to fill the bladder) and a three inch Schedule 40 threaded pipe section sealed by a threaded, gasketed cap, used for releasing air from the filled bladder. Both of these are mounted through a flanged piece of ultra high-molecular weight polyethylene (UHMWP) plate 6 measuring four square inches. A similar air filling assembly 7, excluding the dump valve, is provided at the equator 4 of the bladder 1. This allows for air inflation from the side of the item in the event that top filling is not possible or convenient. An additional dump valve assembly 8, similar to that described above, is provided at the bottom 3 of the bladder 1 and placed at the center point of the cylinder to assist in fully evacuating air from the inflatable item, providing for easier preparation for storage.

Three woven nylon tabs 9 with grommet eyelets are sewn to the main body of the cylinder 1 around the top circumference of the cylinder 1, equally spaced at 120 degrees relative to each other. These are to allow for the use of a hoisting device to retrieve position and/or reposition the device 1 in a vertical or high-angle duct when deployed a significant distance from its point of insertion into the duct or stack. In the final product, these nylon lifting straps may be replaced by loops of vinyl fashioned from the same material as the remainder of the cylinder and sewn in a similar manner. When fully inflated as intended for deployment and use, its appearance is a twelve foot wide by five foot tall cylinder 1 with a rounded top 2.

Initially, the user attaches an air supply using a hose and fixture (the threaded attachment allows for a wide range of fixtures and attachment types). The air supply can be from existing plant pneumatic supply not exceeding 90 psi or from a portable air compressor. Device 1 is then deployed by placing it in its deflated state into the interior of a duct or smokestack 10 and then positioning it at the point at which the item is desired for final placement or use. For short distances, the use of the attached air hose is sufficient for this purpose, although for more distant deployment from the point of insertion, a hoisting device which utilizes the lifting straps would be used. The air supply is then initiated remotely and air is pumped into the bladder/cylinder causing it to inflate. The bladder is filled to a maximum of 5 psi standing interior pressure and the air supply deactivated while leaving the supply hose attached. As the bladder 1 inflates, it will fill and conform to the size and shape of the duct 10 or cylinder, forming a positive seal which will also hold the device in place by means of friction and the interior air pressure impinging on the duct walls. The air supply remains connected which allows for additional air to be introduced in the event the device deflates due to any leakage.

Optionally, a regulator can be attached which performs this automatically.

Once the use of the device is completed, the user simply disconnects the air supply from the air hose, allowing air to leak from the device sufficiently for it to be moved. At this point any personnel below the point of deployment would be evacuated as any dislodged material now resting on the top of the device would be allowed to fail harmlessly below. Once sufficiently deflated, the device could be either repositioned higher or lower in the duct (depending on the user preferences and needs) and then reinflated, or it could be completely removed. Once removed from the duct, the user would remove both dump valve caps and rolls up the device, pushing any remaining air out of the bladder and allowing for compact storage of the device until its next use. The air hose and fittings are removed and the dump valve caps are replaced prior to storage.

In its preferred embodiment, only a single inflatable plug device 1 is used in a cement plant conduit 10. In other words, multiple connected inflatable plug devices are unnecessary, thereby saving part costs, installation time, deflation time, portability, weight and space. In many situations, inflatable device 1 is inflated toward a lower or middle portion of the conduit, for example in smokestack 10, immediately above where the workers are present. Accordingly, the majority of the conduit area above the inflatable device can remain open and unplugged.

The foregoing description of the embodiments has been provided for purposes of illustration and description. It is not intended to be exhaustive or to limit the invention.

Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope and spirit of the present invention.

1. An inflatable safety device for temporarily plugging a conduit or area of a cement manufacturing plant, such as, e.g., vertical or high-angle ducts and stacks, to keep debris from falling on a worker below the device, the device comprising an inflatable bladder (1) made from a resilient material having at least one fill and dump valve assembly (5, 7, 8).

2. An inflatable safety device according to claim 1, wherein the inflatable bladder (1) is configured such that after filling with air the bladder (1) conforms to the size and shape of the conduit (10).

3. An inflatable safety device according to claim 1, wherein the interior air pressure of the bladder (1) is sufficient that the bladder walls (4) impinge on the conduit walls thus forming a positive seal which will also hold the device in place by means of friction.

4. An inflatable safety device according to claim 1, wherein the bladder (1) comprises a top surface (2) that bows upward slightly when fully inflated, presenting a convex surface.

5. An inflatable safety device according to claim 1, wherein the bladder (1) has a cylindrical shape when fully inflated.

6. An inflatable safety device according to claim 1, wherein the bladder (1) is made of heavyweight reinforced vinyl.

7. An inflatable safety device according to claim 6, wherein the bladder (1) comprises a top sheet (2) forming the top surface of the cylinder, a bottom sheet (3) forming the bottom surface of the cylinder bottom surface and a continuous sheet (4) which is stitched into a cylindrical tube to form the walls of the cylinder and which is then stitched to the top (2) and bottom sheets (3).

8. An inflatable safety device according to claim 7, wherein the stitched seams are sealed with an adhesive material to provide air tightness.

9. An inflatable safety device according to claim 1, wherein a fill and dump valve assembly (5) is arranged at the mid-point of the top (2) of the cylinder, a further fill dump valve assembly (8) is arranged at the mid-point of the bottom (3) of the cylinder and a further fill dump valve assembly (7) is provided at the equator (4) of the bladder (1).

10. An inflatable safety device according to claim 1, wherein a threaded pipe section is attached to the fill dump valve assembly (5) and sealed by a threaded, gasketed cap.

11. An inflatable safety device according to claim 1, wherein the fill dump valve assembly (5, 7, 8) is mounted to the bladder (1) through a flanged piece (6) of ultra high-molecular weight polyethylene (UHMWP) plate.

12. An inflatable safety device according to claim 1, wherein a plurality, in particular three tabs (9) with grommet eyelets are attached, preferably sewn to the main body of the bladder (1).

13. An inflatable safety device according to claim 12, wherein the tabs (9) with grommet eyelets are arranged around the top circumference of the cylinder, equally spaced relative to each other.

14. An inflatable safety device according to claim 12, wherein the tabs (9) are made of woven nylon.

15. Method of keeping debris from falling on a worker present in a preferably cylindrical conduit or an area of a cement manufacturing plant, such as, e.g., vertical or high-angle ducts and stacks, by using an inflatable safety device as claimed in claim 1, comprising
a) deploying an inflatable bladder in such areas above where workers must be present, then
b) initiating air supply and pumping air into bladder, thereby
c) inflating the bladder to form an impenetrable barrier against falling brick, refractory, or other material build-up.

16. A method according to claim 15, wherein step a) comprises deploying the bladder by placing it in its deflated state into the interior of the duct or smokestack and then positioning it at the point at which the item is desired for final placement or use.

17. A method according to claim 15, wherein the step of positioning the bladder at the point at which it is desired for final placement or use comprises using a hoisting device which utilizes lifting straps extending through grommet eyelets attached at the circumference of the bladder.

18. A method according to claim 15, wherein step b) comprises filling the bladder with air to a maximum of 5 psi standing interior pressure.

19. A method according to claim 15, wherein step c) comprises, as the bladder inflates, filling and conforming the bladder to the size and shape of the conduit, forming a positive seal which will also hold the device in place by means of friction and the interior air pressure impinging on the duct walls.

20. A method according to claim 15, wherein the air supply remains connected with the bladder which allows for additional air to be introduced in the event the device deflates due to any leakage, whereby, optionally, a regulator can be attached which performs this automatically.

21. Use of an inflatable safety device according to claim 1 for temporarily plugging a conduit or area of a cement manufacturing plant, such as, e.g., vertical or high-angle ducts and stacks, to keep debris from falling on a worker below the device.
